(19) United States
(12) Patent Application Publication
(10) Pub. No.: US 2006/0270409 A1
(43) Pub. Date: Nov. 30, 2006

(54) Grouping messages into a single call trace

(76) Inventors: Juergen Voss, Wiesbaden (DE); Andrew McArthur, Colorado Springs, CO (US)

Correspondence Address: AGILENT TECHNOLOGIES, INC.;Legal Department, DL 429, Intellectual Property Administration, P.O. Box 7599, Loveland, CO, 80537-0599, US

(21) Appl. No.: 11/135,402

(22) Filed: May 24, 2005

(51) Int. Cl. H04Q 7/20

(52) U.S. Cl. 455/442

(57) ABSTRACT

A method, apparatus and computer readable medium having stored thereon computer-executable instructions to facilitate a Universal Mobile Telecommunication System (UMTS) mobile call using a call trace session. The method includes the operations of comparing a plurality of interface captures for lub and lur interfaces to determine whether signaling and user plane messages have a same uplink scrambling code; and combining, automatically, the signaling and user plane messages from different soft handover legs that have the same uplink scrambling code, as determined by said comparing, to yield a composite call trace feature.

### BACKGROUND OF THE INVENTION

The Third Generation (3G) of mobile telecommunications offers substantial increases in data rates over the Second Generation (2G) of mobile telecommunications. In 1998, the Third Generation Partnership Project (3GPP) was formed to continue the technical specification work. 3GPP has five main UMTS standardization areas: Radio Access network, Core Network, Terminals, Services and System Aspects and GSM/EDGE Radio Access Network (GERAN). The UMTS Terrestrial Radio Access group is called UTRA, and defines the UTRA Radio Access Network (UTRAN) for UMTS. Thus, the 3 GPP Radio Access Network is responsible for the radio layer 1, 2 and 3 RR (Radio Resource) specification; the lub (the 3G interface between a Radio Network Controller (RNC) and a Node B (a base station)), the lur (the interface between the 3G (logical) interface between two RNCs), and the lu interfaces (the 3G interface between an RNC and a core network (CN)); developing the UTRAN operation and maintenance requirements; the Base Transceiver System (BTS) radio performance specification, a conformance test specification for testing of radio aspects of base stations; and specifications for radio performance aspects from the system point of view.

Mobile networks allow users to access services while on the move, giving the users freedom in terms of mobility. However, the mobility of the users causes dynamic variations both in the link quality and the interference level, sometimes requiring that a particular user change its serving base station. This process is known as handover (HO). Handover occurs when a call has to be passed from one cell to another as the user moves between cells. In a traditional “hard” handover, the connection to the current cell is broken, and then the connection to the new cell is made. This is known as a “break-before-make” handover. Since all cells in CDMA use the same frequency, it is possible to make the connection to the new cell before leaving the current cell. This is known as a “make-before-break” or “soft” handover. Soft handovers require less power, which reduces the interference and increases capacity. Mobile calls may be connected to more than two base stations during the handover. “Softer” handover is a special case of soft handover wherein the radio links that are added and removed belong to the same Node B.

Call tracing is an effective real-time fault-finding tool for wireless and wireline networks that can aid in correcting call problems. A Call Trace Window illustrates capture of, and decoding of, signaling messages associated with one or more calls to or from a number (or between two numbers), using a line for each call associated with a descrambling code. The trace may be applied to one or more monitored link sets up to and including all links in a network. Captured messages may be exported for off-line analysis. The path of a soft handover signal may be designated as a soft handover leg. In a call tracing system, different soft handover legs on different lub interfaces are indicated as separate call trace lines. There is a need to facilitate handling of the plurality of soft handover legs to improve efficiency and quality for call handling.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of a conventional Third Generation Partnership Project architecture for a UTRAN and a Core Network, wherein the UTRAN is utilized in an embodiment of the present invention.

FIG. 2 illustrates an example of a Traffic Overview Window and a Call Trace Window which may be utilized in an embodiment of the present invention.

FIG. 3 is a block diagram of a call trace apparatus to facilitate a Universal Mobile Telecommunication System (UMTS) call using a call trace session in accordance with an embodiment of the present invention.

FIG. 4 is a flow chart showing operations of a method of facilitating a Universal Mobile Telecommunication System (UMTS) mobile call using a call trace session in accordance with an embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

A UMTS network includes three interacting domains: a CN; a UTRAN; and User Equipment (UE). The CN contains databases and network management functions, and the main function of the core network is to provide switching, routing, and transit for user traffic. The UTRAN provides the air interface access method for UE. A base station is referred to as a Node B, and the control equipment for a Node B is called the RNC.

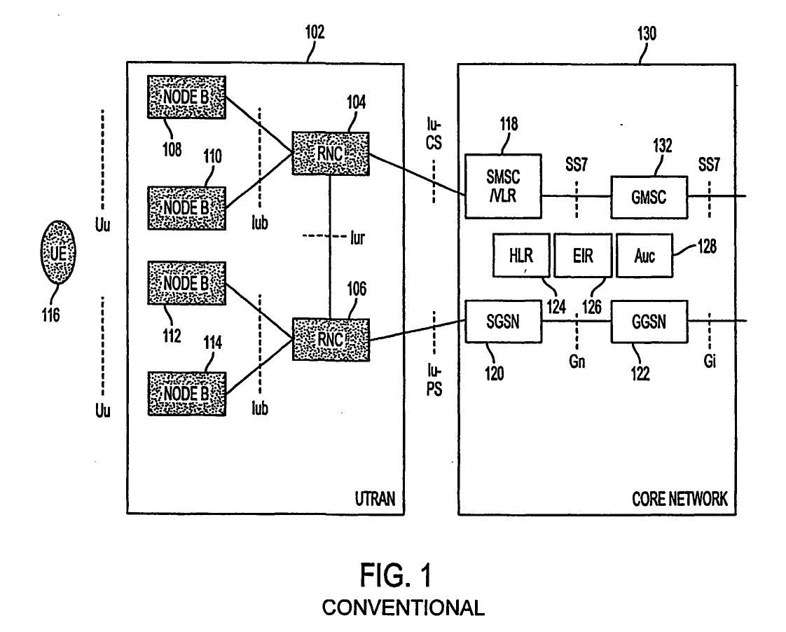

FIG. 1 is a block diagram of a conventional Third Generation Partnership Project architecture for a UTRAN and a Core Network, wherein the UTRAN is utilized in an embodiment of the present invention. The components of UTRAN 102 are the RNC 104, 106 (roughly equivalent to a GSM base station controller), Node B 108, 110, 112, 114 (a base station, roughly equivalent to a GSM base transceiver system), and UE 116 (user equipment, a mobile, which will often be dual-mode, also acting a GSM mobile station). The RNC 104, 106 component of the RAN connects, directly or indirectly, to either a gateway mobile switching center 132 (GMSC) in an SM circuit-switched core/Visitor Location Register (SMSC/VLR) network 118 or a serving GPRS node (SGSN) 120 of a general packet radio service (GPRS) serving a gateway global support node (GGSN) 122 in a packet-switched network. A Home Location Register (HLR) 124, an Equipment Identity Register (EIR) 126 and an Authentication Center (Auc) 128 are also utilized in the Core Network (130).

A network should know the approximate location of the UE in order to be able to page the UE. From largest to smallest, the system areas are designated UMTS systems, Public Land Mobile Network (PLMN), Mobile Switching Center/Visitor Location Register (MSC/VLR or serving GSN (SGSN)), Location Area, Routing Area (PS domain), UTRAN Registration Area (PS domain), Cell, and a Sub-cell.

Wide band CDMA technology was selected to use for the UTRAN air interface. UMTS WCDMA is a Direct Sequence CDMA system wherein user data is multiplied with quasi-random bits derived from WCDMA Spreading codes. In UMTS, in addition to channelization, codes are used for synchronization and scrambling. WCDMA has two basic modes of operation: Frequency Division Duplex (FDD) and Time Division Duplex (TDD).

A Node B (base station) 108, 110, 112, 114 functions to provide air interface transmission/reception, modulation/demodulation, CDMA physical channel coding, micro-diversity, error handling, and closed loop power control.

An RNC 104, 106 functions to provide radio resource control, admission control, channel allocation, power control settings, handover control macro-diversity, ciphering, segmentation/reassembly, broadcast signaling, and open loop power control. Although handover may be performed because a user may be served in another cell more efficiently, that is, with less power emission and/or less interference, handover may be performed for other reasons, for example, system load control.

The UMTS standard does not restrict the functionality of the UE. Terminals work as an air interface counterpart for the Node B and have numerous types of identities. Most of the UMTS identity types are taken directly from the GSM specifications. The UE may act as a mobile station in one of three modes of operation: a PS/CS (packet switched/circuit switched) mode of operation wherein the mobile station (MS) is attached to both the PS domain and the CS domain, and the MS is capable of simultaneously operating PS and CS services; the PS mode of operation, wherein the MS is attached to the PS domain only and may only operate services of the PS domain (but CS-like services may be offered over the PS domain (e.g., VoIP)); and the CS mode of operation, wherein the MS is attached to the CS domain only and may only operate services of the CS domain.

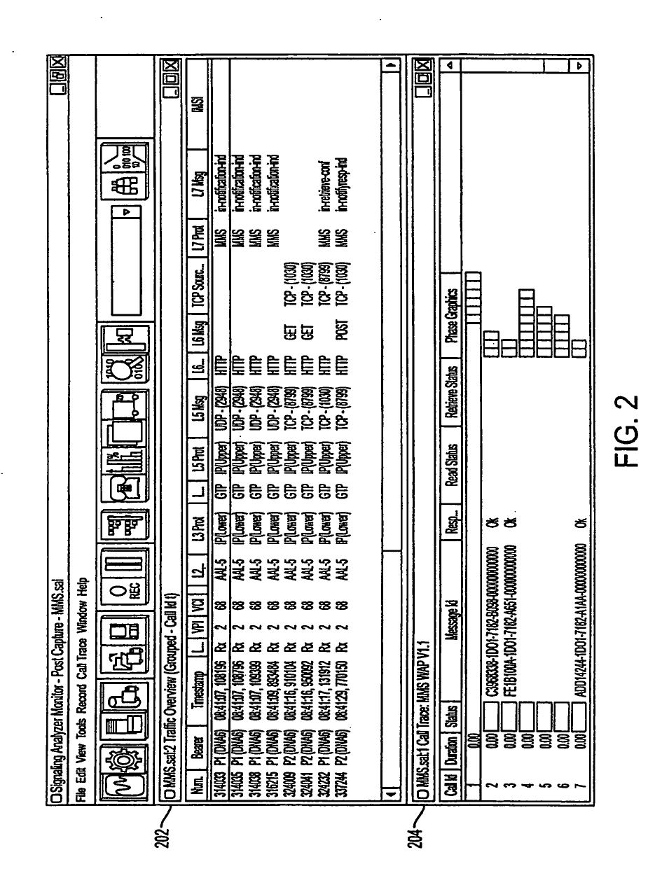

FIG. 2 is an illustrative display of a Traffic Overview Window 202 and a Call Trace Window 204 which may be utilized in an embodiment of the present invention. In the Traffic Overview window, communications transactions are mobile calls that are grouped by Call Id Number. The display includes a series of lines or axes, in this case parallel to one another and extending as horizontal rows across the display. Each row represents the progress of a single call, for example, as shown by the first line in the Traffic Overview window that is highlighted in grey, and has various fields indicating characteristics/successive events of the call. Each event is represented by a block that includes one or more rectangles, the appearance of which is controlled in accordance with the nature of the event represented. For example, the control of appearance may involve, for example, the use of different shades of grey, or different colors, or different graphic symbols. Other graphical components besides rectangular areas may be used.

During a cell search, the UE searches for a cell and determines the downlink scrambling code and frame synchronization of that cell. The cell search is typically carried out in three operations. During the first operation of the cell search, the UE uses the synchronization channel's (SCH's) primary synchronization code to acquire slot synchronization to a cell. This is typically done with a single matched filter, or a similar device, that is matched to the primary synchronization code, which is common to all cells. The slot timing of the cell may be obtained by detecting peaks in the matched filter outputs. During the second operation of the cell search, the UE uses the SCH's secondary synchronization code to find frame synchronization and to identify the code group of the cell found in the first operation. This is done by correlating the received signal with all possible secondary synchronization code sequences, and identifying the maximum correlation value. Since the cyclic shifts of the sequences are unique, the code group, as well as the frame synchronization, is determined. During the third operation, the UE determines the exact primary scrambling code used by the cell that has been located. The primary scrambling code is typically identified through symbol-by-symbol correlation over the CPICH (Common Pilot Channel) with all codes within the code group identified in the second operation. After the primary scrambling code has been identified, the Primary CCPCH (Common Control Physical Channel) may be detected and the system and cell specific BCH (Broadcast Channels) information is read. If the UE has received information about which scrambling codes to search for, operations 2 and 3 may be simplified.

The SCH is a downlink signal used for cell search and consists of two sub-channels, the Primary and Secondary SCH. The 10 ms radio frames of the Primary and Secondary SCH are divided into 15 slots, each of length 2560 chips. The Primary SCH consists of a modulated code of length 256 chips, and the primary synchronization code (PSC) is transmitted once in every slot. The PSC is the same for every cell in the system. The Secondary SCH consists of repeatedly transmitting a length 15 sequence of modulated codes of length 256 chips, the Secondary Synchronization Code (SSC), transmitted in parallel with the Primary SCH. The SSC is denoted cₛ^{i,k}, wherein I=0, 1, . . . , 53 is the number of the scrambling code group, and k=0,1, . . . , 14 is the slot number. Each SSC is chosen from a set of 16 different codes of length 256, which indicates which of the code groups the cell's downlink scrambling code belongs to.

A call trace application is a powerful flexible tool to aid troubleshooting by grouping together all signaling messages that relate to a single call or data session. A large number of calls/sessions may be displayed in this way and errors are easily identified as they are highlighted graphically. The application produces a user-configurable window that contains a single line for each call discovered. The call identification variables and statistics that may be shown in the call trace view are user configurable and may also show variables such as IMSI, setup time, and clear down time. The Call Trace Application allows display of message sequences in multi-segment message flow diagrams. These diagrams allow users to follow control messaging as it flows across multiple network elements. Messaging sequence and discontinuity errors are identifiable.

UMTS call traces may include the lub, lur and lu interfaces. The lub session trace tool for the UMTS lub interface captures and groups the signaling messages for Node B Application Part (NBAP), ALCAP, Radio Resource Control and other protocols. The type of information displayed in the summary view includes Call Identifier, Call Status, Call Duration, Establishment Cause, IMSI (International Mobile Subscriber Identity), TMSI/UP-TMSI (Temporary Mobile Subscriber Identity/User Plane-Temporary Mobile Subscriber Identity), IMEI (International Mobile Equipment Identification), CRNC (Controlling RNC) Communication Context Id (Identification), Node B Communication Context ID, S-RNTI (Serving Radio Network Temporary Identity), SRNC (Serving Radio Network Controller) Identity, Location Area Code, CN (Core Network) Domain Circuit Switched/Packet Switched(CS/PS), Routing Area Code, Various Cause Values, and IP (Internet Protocol) Packet/Octet Counts.

The lu Session Trace Tool for the UMTS lu interface captures and groups the signaling messages for user sessions such as PDP context and UMTS Attach/Detach procedures. The type of information displayed in the summary view includes: Call Identifier, Session Duration, Session Status (Active/Terminated), Service Type, Domain (PS/CS), IMSI, TMSI/P-TMSI, Location Area Code/Service Area Identifier, Service Area Identifier/Service Area Code, Routing Area Code, and IP Packet/Octet Counts.

The lur Session Trace Tool for the UMTS lur interface captures and groups the signaling messages for RNSAP, ALCAP and Radio Resource Control and other protocols. The type of information displayed in the summary view includes: Call Identifier, Call Status, Call Duration, IMSI, SRNC Identity (S-RNTI), DRNC Identity (D-RNTI), Location Area Code/Service Area Identifier, Service Area Identifier/Service Area Code, and Routing Area Code.

The lub & lu Combined Session Trace Tool for the UMTS lur interface captures and groups the signaling messages on the lub and lu interfaces together in a single call. The type of information displayed in the summary view includes: Call Identifier, Call Status, Call Duration, Establish Cause, IMSI, TMSI/P-TMSI, CRNC Communication Context Id, Node B Communication Context ID, S-RNTI, SRNC Identity, Location Area Code, CN Domain (CS/PS), Routing Area Code, Various Cause Values, and IP Packet/Octet Counts for lub and lu.

Soft handover is different from the hard handover process. With hard handover, a definite decision is made on whether to handover or not, and the mobile only communicates with one Node B at a time. With soft handover, a conditional decision is made on whether to handover or not. As the mobile moves, the mobile continuously measures the pilot signal strength received from the nearby Node Bs. Depending on the changes in pilot signal strength from the two or more Node Bs involved, a hard decision will eventually be made to communicate with only one Node B. This generally happens after it is clear that the signal coming from one Node B is significantly stronger than signals from other Node Bs. In the interim period of soft handover, the mobile communicates simultaneously with all the Node Bs in the active set. An active set is a list of cells that are presently having connections with the mobile. Thus, hard handover happens on a time point, and soft handover lasts for a period of time.

In the uplink, the mobile transmits the signals to the air through its omnidirectional antenna. The two Node Bs in the active set can receive the signals simultaneously because of the frequency reuse factor in a CDMA system. Then the signals are passed forward to the RNC for selection combining. In conventional systems, the stronger signal frame is selected and the other is discarded. However, in the present invention, the signal frames from the signals initiated by a single mobile are combined to achieve a combined signal.

During soft handover (SHO), a mobile simultaneously communicates with two (2-way SHO) or more cells belonging to different Node Bs of a same RNC (intra-RNC) or different RNCs (inter-RNC). In the downlink (DL), the mobile receives both signals for maximal ratio combining: in the uplink (UP), the mobile code channel is detected by both Node Bs (2-way SHO), and is routed to the RNC for selection combining. Two active power control loops participate in soft handover: one for each Node B. In the softer handover situation, a mobile is controlled by at least two sectors under one Node B, the RNC is not involved, and there is only one active power control loop. That is, softer handover is a special case of soft handover wherein the radio links that are added and removed belong to the same Node B (i.e., the site of co-located base stations from which server sector-cells are served. In softer handover, macro-diversity with maximum ratio combining can be performed in the Node B, whereas generally in the soft handover on the downlink, macro-diversity with selection combining is applied. SHO and softer handover (HO) are only possible within one carrier frequency and therefore, they are intra-frequency handover processes.

In conventional call trace embodiments, soft handover legs are set up over another lub interface. Captured messages only contain messages to set up additional soft handover legs, and the call trace application indicates the captured messages as a new “call line.” The user has to open two different windows to analyze the initiated call and the soft handover leg. Thus, a time related analysis is not facilitated. The present invention combines multiple soft handoff legs on different lub interfaces related to a call into a call trace session by combining radio links with a same uplink scrambling code, which is specific for each call, to form a composite call trace line. Signaling Analyzing Software indicates all signaling and the user plane in the Traffic Overview window of the Call Trace system relating to a specific call by selecting a same call trace line.

The present invention combines the interface captures for the lub and lur interfaces and groups the signaling messages having a same uplink scrambling code to form one composite call trace feature in a call trace window instead of showing each in a separate row. Hence, the RNC establishes radio links to the mobile for the lub (from Node Bs to an RNC) or lur (from one RNC to another RNC) and then combines the data flow, allowing all signaling and user plane messages from all soft handover legs of a call to be combined on a single call trace line.

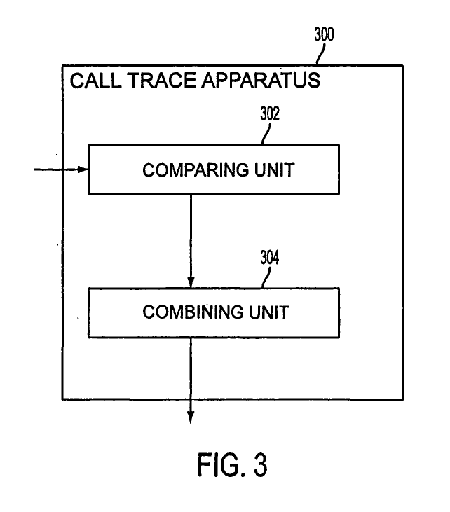

As illustrated in FIG. 3, in an embodiment of the present invention, a call trace apparatus 300 to facilitate a Universal Mobile Telecommunication System (UMTS) call using a call trace session comprises a comparing unit 302 to compare a plurality of interface captures for lub and lur interfaces to determine whether signaling and user plane messages have a same uplink scrambling code; and a combining unit 304 to combine, automatically, the signaling and user plane messages from different soft handover legs that have the same uplink scrambling code, as determined by said comparing, to yield a composite call trace feature. Where selected, the composite call trace feature forms a single call trace line.

In an embodiment of the present invention, the soft handover legs initiated at the mobile unit are received by different Node Bs that communicate with a same Radio Network Controller (RNC) over an interface (lub) between a Node B and an RNC.

In another embodiment of the present invention, the soft handover legs initiated at the mobile unit are received by different Radio Network Controllers (RNCs) that communicate over an interface (lur) between the different RNCs.

In yet another embodiment of the present invention, the soft handover legs are received by different Radio Network Controllers (RNCs) that communicate over an interface (lur) between the different RNCs and are received by different Node Bs that communicate with a same Radio Network Controller (RNC) over an interface (lub) between a Node B and an RNC.

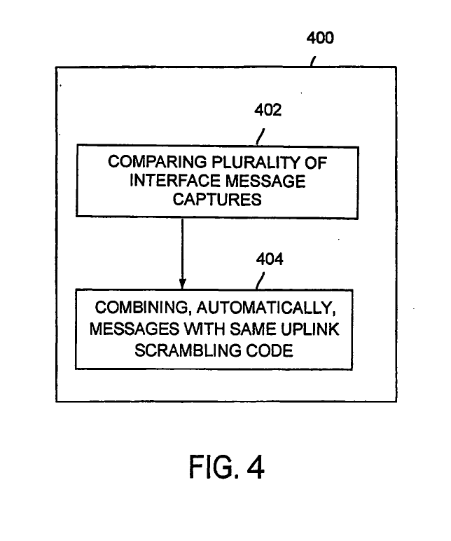

As shown in FIG. 4, numeral 400, an embodiment of the present invention includes a method of facilitating a Universal Mobile Telecommunication System (UMTS) mobile call using a call trace session that comprises comparing a plurality of interface captures for lub and lur interfaces to determine whether signaling and user plane messages have a same uplink scrambling code 402; and combining, automatically, the signaling and user plane messages from different soft handover legs that have the same uplink scrambling code, as determined by said comparing, to yield a composite call trace feature 404. Where selected, the composite call trace feature forms a single call trace line.

In an embodiment of the present invention, the soft handover legs are received by different Node Bs that communicate with a same Radio Network Controller (RNC) over an interface (lub) between a Node B and an RNC.

In another embodiment of the present invention, the soft handover legs are received by different Radio Network Controllers (RNCs) that communicate over an interface (IUR) between the different RNCs.

In yet another embodiment of the present invention, the soft handover legs are received by different Radio Network Controllers (RNCs) that communicate over an interface (lur) between the different RNCs and are received by different Node Bs that communicate with a same Radio Network Controller (RNC) over an interface (lub) between a Node B and an RNC.

In an embodiment of the present invention, a computer-readable medium has stored thereon computer-executable instructions for facilitating a Universal Mobile Telecommunication System (UMTS) call by a mobile unit using a call trace session. The computer-executable instructions comprise comparing a plurality of interface captures for lub and lur interfaces to determine whether signaling and user plane messages have a same uplink scrambling code 402 and combining, automatically, the signaling and user plane messages from different soft handover legs that have the same uplink scrambling code, as determined by said comparing, to yield a composite call trace feature 404. Where desired, the composite call trace feature forms a single call trace line.

In an embodiment of the computer-readable medium of the present invention, the soft handover legs initiated at the mobile unit are received by different Node Bs that communicate with a same Radio Network Controller (RNC) over an interface (lub) between a Node B and an RNC.

In an embodiment of the computer-readable medium of the present invention, the soft handover legs initiated at the mobile unit are received by different Radio Network Controllers (RNCs) that communicate over an interface (lur) between the different RNCs.

In an embodiment of the computer-readable medium of the present invention, the soft handover legs are received by different Radio Network Controllers (RNCs) that communicate over an interface (lur) between the different RNCs and are received by different Node Bs that communicate with a same Radio Network Controller (RNC) over an interface (lub) between a Node B and an RNC.

The present invention may be realized as a code which is recorded on a computer readable recording medium and may be read by a computer. The computer readable recording medium may be any type on which data which may be read by a computer system may be recorded, for example, a ROM, a RAM, a CD-ROM, a magnetic tape, a hard disc, a floppy disc, a flash memory, or an optical data storage device. The present invention may also be realized as a code that is transmitted as carrier waves (for example, transmitted through the Internet). Alternatively, computer readable recording media may be distributed among computer systems connected through a network so that the present invention may be realized as a code which is stored in the recording media and may be read and executed in computers.

Hence, in an embodiment of the present invention, a plurality of interface captures for lub and lur interfaces may be compared to determine whether signaling and user plane messages have a same uplink scrambling code, and the signaling and user plane messages from different soft handover legs that have the same uplink scrambling code may be combined, automatically, as determined by said comparing, to yield a composite call trace feature. The composite call trace feature may form a single call trace line.

Information for the soft handover legs received by different Node Bs that communicate with a same RNC over an interface (lub) between a Node B and an RNC may be combined. Alternatively, information for the soft handover legs received by different RNCs that communicate over an interface (lur) between the different RNCs may be combined. In addition, information for the soft handover legs received by different RNCs that communicate over an interface (lur) between the different RNCs and information for the soft handover legs received by different Node Bs that communicate with a same RNC over an interface (lub) between a Node B and an RNC may be combined.

Thus, in an embodiment of the present invention, a call trace apparatus facilitates call tracing for a Universal Mobile Telecommunication System (UMTS) call by utilizing a comparing unit to compare a plurality of interface captures for lub and lur interfaces to determine whether signaling and user plane messages have a same uplink scrambling code; and a combining unit to combine, automatically, the signaling and user plane messages from different soft handover legs that have the same uplink scrambling code, as determined by said comparing, to yield a composite call trace feature. The composite call trace feature may be selected to form a single call trace line.

The soft handover legs initiated at the mobile unit may be received by different Node Bs that communicate with a same RNC over an interface (lub) between a Node B and an RNC, may be received by different RNCs that communicate over an interface (lur) between the different RNCs, or may be received by a combination of different RNCs that communicate over an interface (lur) between the different RNCs and different Node Bs that communicate with a same RNC over an interface (lub) between a Node B and an RNC.

Also, in an embodiment of the present invention, a computer-readable medium has stored thereon computer-executable instructions for facilitating call tracing in a Universal Mobile Telecommunication System (UMTS) call by a mobile unit. The computer-executable instructions compare a plurality of interface captures for lub and lur interfaces to determine whether signaling and user plane messages have a same uplink scrambling code; and combine, automatically, the signaling and user plane messages from different soft handover legs that have the same uplink scrambling code, as determined by said comparing, to yield a composite call trace feature. The computer-executable instructions may obtain a composite cell trace by combining signaling and user plane messages of the soft handover legs, wherein one of: the soft handover legs initiated at the mobile unit are received by different Node Bs that communicate with a same RNC over an interface (lub) between a Node B and an RNC, the soft handover legs initiated at the mobile unit are received by different RNCs that communicate over an interface (lur) between the different RNCs, or the soft handover legs are received by a combination of different RNCs that communicate over an interface (lur) between the different RNCs and by different Node Bs that communicate with a same RNC over an interface (lub) between a Node B and an RNC.

Although a few preferred embodiments of the present invention have been shown and described, it would be appreciated by those skilled in the art that changes may be made in these embodiments without departing from the principles and spirit of the invention, the scope of which is defined in the claims and their equivalents.

1. A method of automatically searching a hypertext structure for use with a web browser, said method comprising the steps of:
assigning a unique identifier to one or more windows displayed when accessing an URL,
for each of the displayed windows,
generating a data structure corresponding to a tree structuring of a page of HTML in said displayed window, and
copying all nodes of HTML displayed in said displayed window, and storing said copied nodes in said data structure as node information;
when an event occurs with respect to an arbitrary node in any of said displayed windows, recording an address and event type of the node in the copied node in the generated data structure corresponding to the displayed window and node where said event occurred; and
when the occurring event discards one of the displayed windows, discarding said data structure corresponding to the discarded window,
wherein a sequence of occurring events in connection with said URL are recorded in the form of a corresponding sequence of records for said URL, each record identifying an address and an event type and the sequence of records uses as a key each assigned unique identifier of a window.

2. A method according to claim 1, wherein said event type is a click by a mouse (Click), submit (Submit) for entering information in a form element or selection of information with a mouse (Selected).

3. A method according to claim 1, further comprising the step of:
invoking said sequence to thereby automatically manipulate a web browser in accordance with the invoked sequence of records to access a desired WWW page and acquire desired information.

4. A method according to claim 3, further comprising the step of:
when the configuration of a page in the middle of automatic access is different from the configuration at the time of recording, a user is notified thereof and urged to access said page again.

5. A method according to claim 3, further comprising the step of:
when the configuration of a page in the middle of automatic access is different from the configuration at the time of recording an event corresponding to the page, continuing the processing using previously recorded information.

6. A program for executing a function of automatically searching a hypertext structure in a web browser, by causing a computer to go through the steps of:
assigning a unique identifier to one or more windows displayed when accessing an URL,
for each of the displayed windows,
generating a data structure corresponding to a tree structure of a page of HTML in said displayed window, and
copying all nodes of HTML displayed in said displayed window, and storing said copied nodes in said data structure as node information;
when an event occurs with respect to an arbitrary node in any of said displayed windows, recording an address and event type of the node in the copied node in the generated data structure corresponding to the displayed window and node where said event occurred; and
when the occurring event discards one of the displayed windows, discarding said data structure corresponding to the discarded window,
wherein a sequence of occurring events in connection with said URL are recorded in the form of a corresponding sequence of records for said URL, each record identifying an address and an event type and the sequence of records uses as a key each assigned unique identifier of a window.

7. An apparatus for automatically searching a hypertext structure for use with a web browser, said apparatus comprising:
a device for assigning a unique identifier to one or more windows displayed when accessing an URL,
a device for generating, for each of the displayed windows, a data structure corresponding to a tree structure of a page of HTML in said displayed window,
a device for copying, for each of the displayed windows, all nodes of HTML displayed in said displayed window, and storing said copied nodes in the corresponding data structure as node information;
a device for, when an event occurs with respect to an arbitrary node in any of said displayed windows, recording an address and event type of the node in the copied node in the generated data structure corresponding to the displayed window and node where said event occurred; and
a device for, when the occurring event discards one of the displayed windows, discarding said data structure corresponding to the discarded window,
wherein a sequence of occurring events in connection with said URL are recorded in the form of a corresponding sequence of records for said URL, each record identifying an address and an event type and the sequence of records uses as a key each assigned unique identifier of a window as a key.

8. A method according to claim 1, wherein said URL is used as a key of said sequence of records.

9. A method according to claim 1, wherein said occurring events are web browsing events.

10. A method according to claim 1, wherein a plurality of windows are displayed when accessing the URL, the method further comprising:
assigning a unique identifier to each of the plurality of displayed windows.

11. A program according to claim 6, wherein said URL is used as a key of said sequence of records.

12. A program according to claim 6, wherein said occurring events are web browsing events.

13. A program according to claim 6, wherein a plurality of windows are displayed when accessing the URL, the method further comprising:
assigning a unique identifier to each of the plurality of displayed windows.

14. An apparatus according to claim 7, wherein said URL is used as a key of said sequence of records.

15. An apparatus according to claim 7, wherein said occurring events are web browsing events.

16. An apparatus according to claim 7, wherein
a plurality of windows are displayed when accessing the URL, and
the device for assigning assigns a unique identifier to each of the plurality of displayed windows.
